(19) United States
(12) Patent Application Publication
(10) Pub. No.: US 2015/0217502 A1
(43) Pub. Date: Aug. 6, 2015

(54) DEVICE AND METHOD FOR PRODUCING STRUCTURED PLASTIC YARNS

(71) Applicant: Voith Patent GmbH, Heidenheim (DE)

(72) Inventor: Jürgen Abraham, Nattheim (DE)

(73) Assignee: VOITH PATENT GMBH, Heideneheim (DE)

(21) Appl. No.: 14/689,624

(22) Filed: Apr. 17, 2015

Related U.S. Application Data
(63) Continuation of application No. PCT/EP2013/071471, filed on Oct. 15, 2013.

(30) Foreign Application Priority Data
Oct. 19, 2012 (DE) 10 2012 219 103.8

(51) Int. Cl. B29C 53/56; B29C 43/24

(52) U.S. Cl. CPC B29C 53/564; B29C 43/24; B29L 2031/726

(57) ABSTRACT

A device for producing plastic spirals for use in a machine for producing a fibrous web includes at least two rolls between which an adjustable roll nip is formed. The rolls have a shape which differs in at least one region from a cylinder shape and/or have a surface structure in at least one region on the surface thereof.

### CROSS REFERENCE TO RELATED APPLICATIONS

This is a continuation of PCT application No. PCT/EP2013/071471, entitled “DEVICE AND METHOD FOR PRODUCING STRUCTURED PLASTIC YARNS, PLASTIC YARN AND SPIRAL FABRIC MADE FROM PLASTIC YARN”, filed Oct. 15, 2013, which is incorporated herein by reference.

### BACKGROUND OF THE INVENTION

1. Field of the Invention

The invention is directed to a device for producing plastic spirals, a method for producing plastic spirals using such a device, a plastic spiral thus produced, and a spiral fabric consisting of such plastic spirals.

2. Description of the Related Art

Textile clothing is found in a multitude of positions in machines for the production of fibrous web material, for example in paper or cardboard machines. In the forming section, the clothing facilitates sheet formation and dewatering; in the press section, absorption of water pressed from the fibrous web; in transfer positions, transfer into the next machine section; and in all sections it supports the fibrous web material.

In the dryer section of a fibrous web machine, clothing—normally referred to as dryer fabric—in addition to supporting the fibrous web, serves to increase the drying efficiency and the energy efficiency of the dryer section. The dryer fabrics must be thin and, at the same time, dimensionally stable with low stretch, must not mark the fibrous material, not carry along air, provide optimal moisture removal, must have optimal sheet release characteristics, and ensure a uniform drying profile across the width of the fibrous web material.

In particular, the last two characteristics are very strongly associated with the surface structure of the yarns forming the dryer fabric, whereas the characteristics of not marking the material and the high dimensional stability are also determinable through the cross sectional shape of the yarns.

Among other arrangements, today's dryer fabrics consist of spiral structures wherein plastic spirals are formed from plastic yarns which are deposited overlapping adjacent next to one another in such a way that the individual spirals can be connected with pintle wires. The yarns used for this type of spiral fabric structures are either round or are already provided with a cross sectional shape that deviates from the round shape which can be, for example, flat-oval or approximately rectangular.

A device to produce spirals from plastic yarns is known from WO09/130036 A1, comprising a winding device for the yarns which includes a guide rotatable around its axis, and having a forming body onto which the spirals are deposited by means of the winding device and from which they can be pulled. For the cross section of the respective yarn, a forming device that is rotatable with the winding device is assigned to the winding device. Accordingly, the produced spirals have a cross sectional shape that is determinable and can be adjusted to the aforementioned desirable characteristics of a dryer fabric.

A disadvantage with the produced plastic spirals is that although a change in the cross-sectional shape of the wire is achieved, its surface, in particular on a microscopic scale, is not altered. This results in the dryer fabrics becoming dirty quickly and, as a result, cannot fulfill their tasks. Deteriorations are noted in sheet release, in the drying efficiency due to poorer moisture removal, and variable moisture cross profiles in the fibrous web material.

What is needed in the art is a device and a method by which the yarns provided for the production of plastic spirals can be produced in a way that overcomes some of the known disadvantages of the prior art.

### SUMMARY OF THE INVENTION

The invention provides a device and method by which the yarns provided for the production of plastic spirals can be influenced during the manufacturing process not only in their cross sectional shape, but also in their surface structure. An accordingly formed and structured yarn and a spiral fabric can produced from the yarn. The plastic spirals that can be formed and structured in one simultaneous process step. This can occur by accordingly shaped rolls mounted in a roller bearing assembly that, in addition to a suitable shape for cross section deformation of the previously extruded yarns, have a surface design which embosses a structure into the yarn surface.

The rolls can have a shape which differs, at least in regions, from a cylindrical shape and/or have a surface structure so that the surface design of the yarn can be discretionary in order to obtain the desired characteristics profile.

In one embodiment, a shell surface of the rolls—at least in regions—has the shape of single, dual or multiple hyperboloid of revolution, of cones or tapers. This provides an easily realizable engineering adaptation of existing devices for the production of plastic spirals for spiral fabrics.

The surface structures of the rolls can be in the form of strips, ribs, grooves, or wavy lines.

The strips, ribs, grooves or wavy lines can assume random positions between axially parallel to an axis of the rolls and parallel to a circumferential direction of the rolls.

According to another embodiment of the invention, it may be provided that the surface structures are designed in the form of protrusions of various shapes, or recesses of various shapes.

The surface structures may be distributed evenly or unequally over the surface of the rolls.

According to another embodiment of the invention the surface structures may be designed as a macro-structure and/or a micro-structure. The macro-structure can have a size range of 0.9 mm to 0.9 μm. The micro-structure can have a size range of 0.9 μm to 0.01 μm.

The depth of the surface structures can be 0.01 μm to 0.3 mm, such as 0.01 mm to 0.2 mm.

The distance between two adjacent surface structures may be 0.1 μm to 0.9 mm, or 0.01 mm to 0.6 mm.

The roughness in the region of the surface structure can be less than 0.3.

A method for the production of plastic spirals by winding plastic yarn into individual spirals that are inserted into each other, overlapping in cross direction on a work surface and are merged with pintle wires into flat structure can provide that, after being wound, the spirals are deposited next to one another on the work surface and are engaged with each other on this work surface through a joining device and are respectively connected with one another by the pintle wires. The spirals are thereby produced by the at least one winding device and after thermal forming are placed—due to a movement of the joining device —besides a guide rail on the work surface. The respectively subsequent spirals are placed on the work surface between the guide rail and the spirals previously placed on the work surface due to the movement of their winding device and the joining device which is located downstream from it. The at least one previously placed spiral is moved in a transverse direction on the work surface through movement of the joining device by a measure of the overlap, and the respectively last placed spirals are respectively connected with each other by at least one inserted pintle wire, and the yarn is formed in a roller bearing assembly. The roller bearing assembly is designed with at least two rolls with a roll nip between them through which the yarn is guided and a change of the outside shape and/or surface of the yarn occurs.

The change in the shape of the yarn can occur through an appropriate shape of the rolls mounted in the roller bearing assembly.

The change to the surface of the yarn can occur through embossing of a surface structure that is provided on at least one of the rolls, at least partially, into the yarn.

A plastic spiral for the use in dryer fabrics in the dryer section of a machine for the production of a fibrous web such as a paper or cardboard web can be produced according to the aforementioned method. The yarn forming the plastic spiral has a cross sectional shape deviating from a round shape and/or the yarn forming the plastic spiral has at least partial surface structuring.

The surface structuring can be in the form of strips, ribs, grooves, wavy lines, protrusions of various shapes and/or recesses of various shapes.

According to one embodiment of the invention, the strips, ribs, grooves or wavy lines can assume random positions between parallel to a direction of extension of the yarn and parallel to a circumferential direction of the yarn.

The surface structures may be distributed evenly or unequally over the surface of the yarn.

One embodiment of the invention provides that the surface structuring is done at least partially on one outside and/or on one inside of the plastic spiral after laying the yarn into the spiral shape.

The surface of the plastic spiral can have a roughness of less than 0.3.

A spiral fabric for use in a machine for the production of a fibrous web such as a paper or cardboard web, comprises a plurality of plastic spirals that are connected with one another by pintle wires. The plastic spirals are provided at least partially with a surface structuring which positively influences dirt resistance and sheet release characteristics of the spiral fabric, thus providing constant quality of the produced fibrous web.

According to another embodiment of the invention, plastic spirals having different surface structures can be combined in unequal or equal sequences, whereby the sheet release characteristics can be significantly improved.

The spiral fabrics according to the invention can be used in a multitude of locations in the paper machine, such as forming fabric or dryer fabric, but also as the base structure for a press felt.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a sectional view of a device for the production of plastic spirals according to the prior art;

FIG. 2A is a schematic view of an embodiment of a roller bearing assembly according to the present invention that can be used in the device shown in FIG. 1;

FIG. 2B is a schematic view of another embodiment of a roller bearing assembly according to the present invention that can be used in the device shown in FIG. 1;

FIG. 3A is a schematic view of a plastic spiral with a surface structure that can be produced using the devices shown in FIGS. 1-2;

FIG. 3B is a schematic view of another plastic spiral with a surface structure that can be produced using the devices shown in FIGS. 1-2;

FIG. 3C is a schematic view of yet another plastic spiral with a surface structure that can be produced using the devices shown in FIGS. 1-2; and

FIG. 4 is a schematic lateral view of an individual loop of a plastic spiral with embossed surface structures that can be produced according to the present invention.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

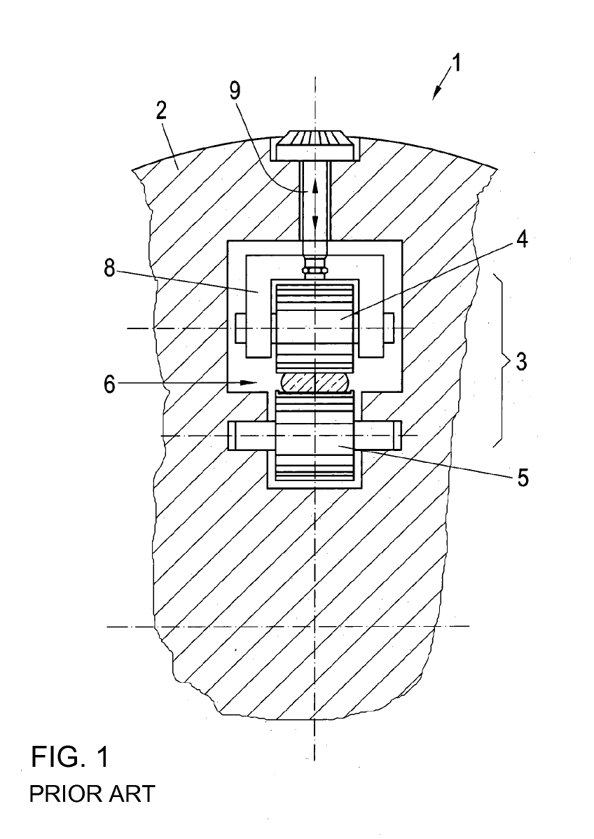

Referring now to the drawings, FIG. 1 shows a strongly schematized sectional view of a device 1 for producing plastic spirals for production of paper machine clothing, in particular spiral fabrics for use in the dryer section of a paper or cardboard machine according to the current state of the art.

Such devices 1 are known so a detailed description of device 1 is omitted. The device is described only in regard to its invention-relevant components, in order to simplify understanding of the present invention.

Device 1 include a housing 2 where a roller bearing assembly 3 is disposed. The roller bearing assembly includes a first roll 4 and a second roll 5 between which a roll nip 6 is formed. In roll nip 6, an already deformed yarn 7 can be seen that has been transformed into a longitudinal oval cross sectional shape from an original approximately round cross sectional shape in which it, for example, exits an extruder that is not illustrated.

First roll 4 is mounted adjustably in an adjustment device 8, while second roll 5 is mounted stationary in housing 2. The adjustment of the position and the drive of first roll 4 are possible via a drive 9 which is arranged suitably in housing 2.

Rolls 4 and 5 that are mounted in roller bearing assembly 3 are smooth and cylindrical according to the current state of the art. Deformation of yarn 7 therefore occurs only by moving first roll 4 closer to second roll 5 by reducing roll nip 6 and a corresponding displacement of the still deformable plastic material of yarn 7 toward the outside.

The produced yarn 7 with altered cross section therefore has an altered cross section, but a smooth surface. Accordingly, the previously discussed properties of yarn 7, or respectively of the dryer fabric produced from yarn 7, are not satisfactory in regard to sheet release and dirt resistance.

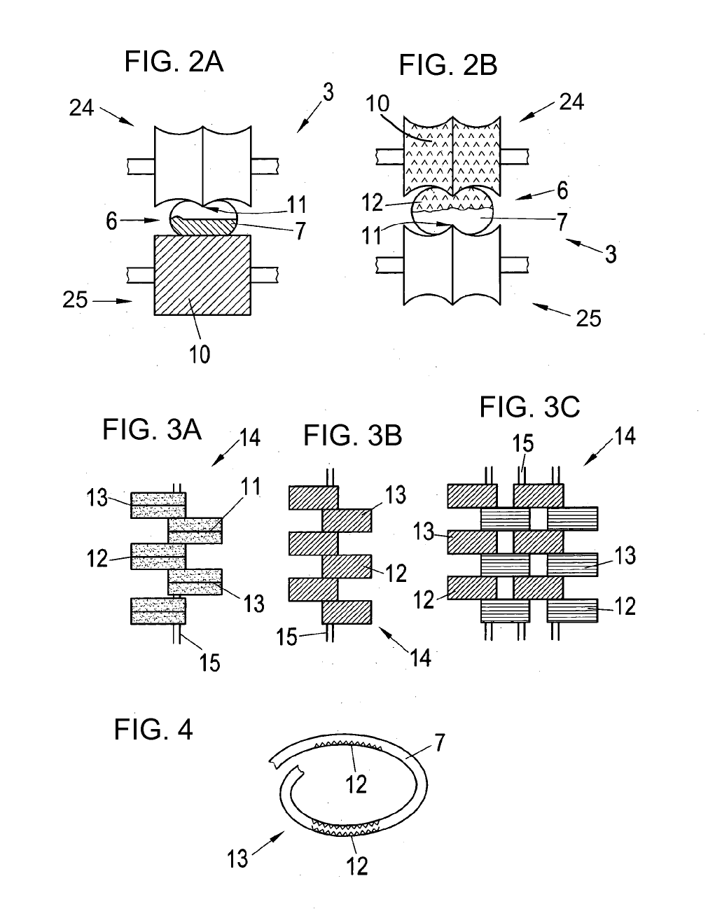

Remedial action can be provided by modification of rolls 4 and 5 that are mounted in roller bearing assembly 3. Such modified rolls 24 and 25 are illustrated in FIGS. 2A and 2B according to the present invention. In order to maintain clarity, only rolls 24 and 25 respectively are shown in FIGS. 2A and 2B, as well as yarn 7.

In FIG. 2A, a combination is shown of a first roll 24 which has a double hyperbolic rotational shape with a second roll 25 which is cylindrical and which is provided with a surface structure 10.

First roll 24 imparts a macroscopic structure to yarn 7 which, in this case, can produce a groove 11 in the longitudinal direction of the yarn, whereas second roll 25 provides yarn 7 with surface structuring 12 which is imparted into the material of yarn 7 by pressing into surface structure 10 of roll 5.

Consequently, a yarn 7 is obtained which, on one top side and one bottom side can have differently designed surface shapes and structures. Depending on the orientation of yarn 7 in the subsequent plastic spiral, groove 11 can point inward or outward, and embossed surface structure 12 can point inward or outward.

FIG. 4 shows an example of a single loop of a plastic spiral in whose upper region only a surface structuring 12 is visible, whereas yarn 7 may, for example, be provided with groove 11 on the outside (not visible in FIG. 4).

In FIG. 2B, an additional embodiment of a roller bearing assembly 3 according to the present invention is shown, where both rolls 24 and 25 have a double hyperbolic rotational shape and accordingly impart a shape with grooves 11 onto the top and bottom side of yarn 7.

First roll 24 moreover has a surface structure 10 which is shark skin like. This produces a corresponding surface structuring 12 on yarn 7 which provides excellent characteristics in regard to dirt and water resistance, as well as to flow properties of air and water. Such effects (for example the so-called Lotus-effect) are known from nature and are used in many ways technologically.

There are hardly any limits in regard to the shape of rolls 24 and 25 and to the arrangements of their surface structures 10. Any combination of single, double or multiple hyperboloids of revolution, as well as combinations of conical, cylindrical or optional other geometrical shapes are possible.

Surface structures 10 can be in the form of strips, ribs, grooves or wavy lines and can assume positions parallel, tilted or diagonal relative to the roll axis, as far as to the circumferential direction of the rolls. Protrusions in any discretionary shape or recesses in any discretionary shape, even or uneven, can be distributed at least over regions over the surface of rolls 24, 25. Several surface structures 10 may also be combined on one of the rolls 24, 25. Moreover, it is possible to combine, for example, the rotational hyperbolic shape with a surface structure 10.

Dimensioning of surface structures 10 can thereby be divided into a macro- and a micro-structuring which can be used individually or in combination with each other. The macrostructure may have a size range of 0.9 μm to 0.9 mm, whereas the microstructure can have a size range of 0.01 μm to 0.9 μm.

The depth of surface structures 10 can be 0.01 μm to 0.3 mm or 0.01 mm to 0.2 mm. A distance between two adjacent surface structures 10 can be 0.1 μm to 0.9 mm or 0.01 mm to 0.6 mm.

The roughness in the region of surface structures 10 can be less than 0.3 so that the surface roughness of yarns 7 is also less than 0.3.

Suitable limiting elements (not illustrated) in roll nip 6 can limit the width of squeezed yarn 7 and produce an almost rectangular cross sectional shape. By structuring these limiting elements, the sides of yarn 7 can also undergo targeted structuring.

FIGS. 3A, 3B and 3C illustrate examples of several plastic spirals 13 which together form a dryer fabric 14. Plastic spirals 13 are held together in a generally known manner by pintle wires 15.

As shown in FIG. 3A, the plastic spirals 13 can each be provided with an embossed groove 11, as well as an overlaid surface structuring 12.

As shown in FIG. 3B, the plastic spirals 13 can all be provided with a diagonally progressing groove-type surface structuring 12.

As shown in FIG. 3C, a combination of two differently arranged plastic spirals 13 can be arranged always alternating. Spiral fabrics of this type can be produced in one work cycle wherein several spiral producing units are operated with different embossing units.

As already mentioned, FIG. 4 illustrates a single loop of a plastic spiral 13 which can be used in a dryer fabric 14 for a paper or cardboard machine which is provided in the upper region on its inside and in the lower region on its outside with a surface structuring 12, as previously described. The diverse arrangement of surface structuring 12 may have a variety of consequences in regard to the performance of plastic spiral 13 or, respectively, subsequently in the dryer fabric. An improved dirt resistance on the inside of plastic spiral 13 results in greater uniform drying efficiency, since the open volume of the dryer fabric still remains intact even after prolonged use. Exterior surface structures 12 can improve the sheet release characteristics, in particular if differently structured plastic spirals 13 alternate with each other, as illustrated in FIG. 3C.

Different structuring can be provided on the outside and on the inside of plastic spiral 13, thereby being able to achieve different characteristics. Transverse structuring of the inside simplifies insertion of pintle wires 15, whereas with other suitable structuring the fixation of filler wires can be favored. At the same time, a modification can be provided on the outside that is different from the structuring on the inside, for example, with the objective to influence the sheet release characteristics or to reduce the contamination susceptibility.

Utilization of described plastic spirals 13 is possible in almost any paper machine clothing, such as dryer fabrics and former fabrics. Use as base structure for press felts is also conceivable and possible.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A device for producing plastic spirals for use in spiral fabrics in a machine for the production of a fibrous web, comprising:
at least two rolls between which an adjustable roll nip is formed, said at least two rolls each having a surface and at least one of a shape deviating in at least one region from a cylindrical shape and a surface structure in at least one region of said surface.

2. The device according to claim 1, wherein said at least two rolls include a shell surface having a shape in at least one region that one of tapers and is one of a one of single, dual, and multiple hyperboloid of revolution and of cones.

3. The device according to claim 1, wherein at least one of said at least two rolls has surface structures formed as one of strips, ribs, grooves, and wavy lines.

4. The device according to claim 3, wherein said at least two rolls define an axis and a circumferential direction, said surface structures assuming random positions between axially parallel to said axis and parallel to said circumferential direction.

5. The device according to claim 4, wherein said surface structures are distributed one of evenly and unequally over said surface of said at least two rolls.

6. The device according to claim 3, wherein said surface structures are formed as one of protrusions of various shapes and recesses of various shapes.

7. The device according to claim 3, wherein said surface structures are formed as at least one of a macro-structure and a micro-structure.

8. The device according to claim 7, wherein said macro-structure has a size range of 0.9 μm to 0.9 mm.

9. The device according to claim 7, wherein said micro-structure has a size range of 0.01 μm to 0.9 μm.

10. The device according to claim 3, wherein said surface structure have a depth of 0.01 μm to 0.3 mm.

11. The device according to claim 3, wherein a distance between two adjacent surface structures is 0.1 μm to 0.9 mm.

12. The device according to claim 1, wherein a roughness in said region of said surface with said surface structure is less than 0.3.

13. A method for the production of plastic spirals, comprising the steps of:
forming plastic yarn in a roller bearing assembly having at least two rolls with a roll nip between the rolls through which said yarn is guided and a change of at least one of an outside shape and surface of said yarn occurs;
winding said yarn into individual spirals that are inserted into each other using at least one winding device;
depositing said spirals next to one another on a work surface;
engaging said spirals to each other on said work surface through a joining device located downstream from said at least one winding device;
placing said spirals besides a guide rail on said work surface using a movement of said joining device;
placing subsequent spirals on said work surface between said guide rail and said spirals previously placed on said work surface due to the movement of their winding device and said joining device;
moving at least one previously placed spiral in a transverse direction on said work surface through movement of said joining device by a measure of overlap; and
connecting spirals moved according to said previous step to one another using at least one inserted pintle wire.

14. The method according to claim 13, wherein a change in the shape of said yarn occurs through an appropriate shape of said at least two rolls that are mounted in said roller bearing assembly.

15. The method according to claim 13, wherein a change to the surface of said yarn occurs through at least partial embossing of a surface structure that is provided on at least one of said at least two rolls into said yarn.

16. The method according to claim 13, further comprising the step of producing a plastic spiral formed from said yarn wherein said yarn has at least one of surface structuring in at least one section and a shape deviating from a round cross section.

17. The method according to claim 16, wherein said yarn has a surface structuring formed as at least one of strips, ribs, grooves, wavy lines, protrusions of various shapes, and recesses of various shapes.

18. The method according to claim 17, wherein said yarn defines a direction of extension and a circumferential direction, said surface structuring assuming random positions between parallel to said direction of extension and parallel to said circumferential direction.

19. A spiral fabric for use in a machine for the production of a fibrous web, comprising:
a plurality of plastic spirals connected with one another by pintle wires, said plurality of plastic spirals are provided at least partially with a surface structuring.

20. The spiral fabric according to claim 19, wherein said plastic spirals having different surface structures are combined in one of unequal and equal sequences.
